(19) United States
(12) Patent Application Publication
(10) Pub. No.: US 2011/0234379 A1
(43) Pub. Date: Sep. 29, 2011

(54) AUTOMATIC TRANSMISSION APPARATUS AND METHOD OF AUTOMATIC-TRANSMITTING SIGNAL BETWEEN EFID TAG AND MOBILE TERMINAL IN THE SAME

(75) Inventor: Sang Hoon Lee, Seoul (KR)

(73) Assignee: AQ CO., LTD., Seoul (KR)

(21) Appl. No.: 13/131,753

(22) PCT Filed: Dec. 16, 2009
(86) PCT No.: PCT/KR2009/007514

§ 371 Date: May 27, 2011

(30) Foreign Application Priority Data
Aug. 18, 2009 (KR) 10-2009-0075995

(51) Int. Cl. H04Q 5/22

(52) U.S. Cl. 340/10.1

(57) ABSTRACT

An automatic transmission apparatus includes an RFID tag including a one-shot call command data signal, a one-shot SMS command data signal and/or a one-shot Internet access command data signal, and a mobile terminal that includes an RF antenna, a base band chip, and an NFC controller that performs NFC with the RFID tag, and transmits the command data signal received from the RFID tag to the base band chip. Once a mobile terminal is tagged on the RFID tag, the mobile terminal performs call connection by automatically linking to a telephone number stored in the RFID tag, automatically links an SMS stored in the RFID tag on the screen of the mobile terminal so that the SMS may be activated, and/or automatically links to a particular address by using the web browser of the mobile terminal according to an Internet address stored in the RFID tag.

### CROSS REFERENCE TO RELATED APPLICATION AND CLAIM OF PRIORITY

The present application claims all benefits accruing under 35 U.S.C. §365(c) from the PCT International Application PCT/KR2009/007514, with an International Filing Date of Dec. 16, 2009, which claims the benefit of Korean patent application No. 10-2009-0075995 filed in the Korean Intellectual Property Office on Aug. 18, 2009, the entire contents of which are incorporated herein by reference.

### BACKGROUND OF THE INVENTION

1. Field of the Invention

The present invention relates to an automatic transmission apparatus and a method of automatic-transmitting signal between EFID TAG and a mobile terminal in the automatic transmission apparatus.

2. Description of the Related Art

Stickers, including RFID tags, attached to a refrigerator, a washing machine, and a vehicle have frequently been used.

Such a sticker, including an RFID tag, has been chiefly used only to recognize a vehicle at the entrance/exit of a parking lot or to track and detect the location of a product when the product is shipped from a factory.

Further, a sticker, including an RFID tag, performs only a display function. Accordingly, contact with the owner of a vehicle parked in a parking lot should be made by viewing the mobile phone number of the owner of the vehicle and pressing numbers corresponding to the mobile phone number one by one. In the case of short term parking because of the urgency of business, it is difficult to transmit a message to the mobile terminal of another party, thereby causing a small quarrel.

### SUMMARY OF THE INVENTION

According to an aspect of the present invention, an automatic transmission apparatus including: at least one Radio Frequency Identification (RFID) tag including a command data signal that includes at least one of a one-shot call command data signal, a one-shot SMS command data signal and a one-shot Internet access command data signal; a mobile terminal including: a Radio Frequency (RF) antenna; a base band chip; and a Near Field Communication (NFC) controller electrically connected to the base band chip, the NFC controller configured to perform NFC with the RFID tag via the RF antenna, and to transmit the command data signal received from the Radio Frequency Identification (RFID) tag to the base band chip.

The NFC controller may perform NFC with the RFID tag over a band of 13.56 MHz.

The NFC controller may includes: a Read Only Memory (ROM) emulator for storing the command data signal received from the RFID tag via the RF antenna; a contactless front end unit to transmit the command data signal contactlessly received via the RF antenna to the ROM emulator, and exchange information about response data transmitted from the base band chip via the RF antenna; a Peer-to-Peer (P2P) communication unit to exchange information with another mobile terminal using a P2P method; and a Universal Subscriber Identity Module (USIM) card-contactless Asynchronous Receiver/Transmitter (DART) unit including a communication interface input terminal and a communication interface output terminal which are connected to a USIM card in conformity with a Single Wired Protocol (SWP), the Universal Subscriber Identity Module (USIM) card-contactless Asynchronous Receiver/Transmitter (DART) unit transmitting the command data signal received from the RFID tag to the USIM card via the RF antenna and performing network authentication, electronic commerce, and global roaming communication service using the USIM card.

The base band chip may be electrically connected to the NFC controller, is driven in a one-shot call mode in response to the one-shot call command data signal transmitted from the NFC controller, is driven in a one-shot SMS mode in response to the one-shot SMS command data signal, and is driven in a one-shot Internet access mode in response to the one-shot Internet access command data signal.

The mobile terminal may further include a tag circuit unit to amplify the one-shot call or SMS command data signal received via the RF antenna, transmit the amplified command data signal to the contactless front end unit of the NFC controller, modulate response data transmitted from the NFC controller, and transmit the modulated response data to the RF antenna; and a receiver circuit unit to pass and amplify the one-shot Internet access command data signal which is read and received via the RF antenna, demodulate the amplified one-shot Internet access command data signal into a digital signal, and then transmit the demodulated one-shot Internet access command data signal to the NFC controller.

According to another aspect of the present invention, a method of automatic transmitting a signal in an automatic transmission apparatus, the method includes: setting a command data signal in an external RFID tag, the command data signal selected from among a one-shot call command data signal, a one-shot Short Message Service (SMS) command data signal and a one-shot Internet access command data signal; tagging a mobile terminal with the external RFID tag to receive the command data signal from the external RFID tag and transmit the command data signal to a base band chip; selecting any one of a one-shot call mode, a one-shot SMS mode, and a one-shot Internet access mode in response to the command data signal transmitted from the NFC controller; and driving the selected mode.

According to yet another aspect of the present invention, a mobile terminal performing Near Field Communication with an external Radio Frequency Identification (RFID) tag, the mobile terminal includes: a Radio Frequency (RF) antenna; a Near Field Communication (NFC) controller configured to perform NFC with the external RFID tag via the RF antenna, and to transmit a command data signal received from the external Radio Frequency Identification (RFID) tag to a base band chip, the command data signal including at least one of a one-shot call command data signal, a one-shot SMS command data signal, a one-shot Internet access command data signal and a combination thereof, and the base band chip electrically connected to the NFC controller, the base band chip being driven in a one-shot call mode in response to the one-shot call command data signal transmitted from the NFC controller, in a one-shot SMS mode in response to the one-shot SMS command data signal, and in a one-shot Internet access mode in response to the one-shot Internet access command data signal.

The mobile terminal may be a mobile phone.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the components of an automatic transmission apparatus and having a one-shot call function, a one-shot SMS function, and a one-shot Internet access function performed through an NFC controller according to an embodiment of the present invention;

FIG. 2 is a block diagram illustrating the components of the NFC controller according to an embodiment of the present invention;

FIG. 3 is a block diagram illustrating the peripheral devices of the NFC controller according to an embodiment of the present invention;

FIG. 4 is a circuit diagram illustrating the components of a tag circuit unit according to an embodiment of the present invention;

FIG. 5 is a circuit diagram illustrating the components of a receiver circuit unit according to an embodiment of the present invention;

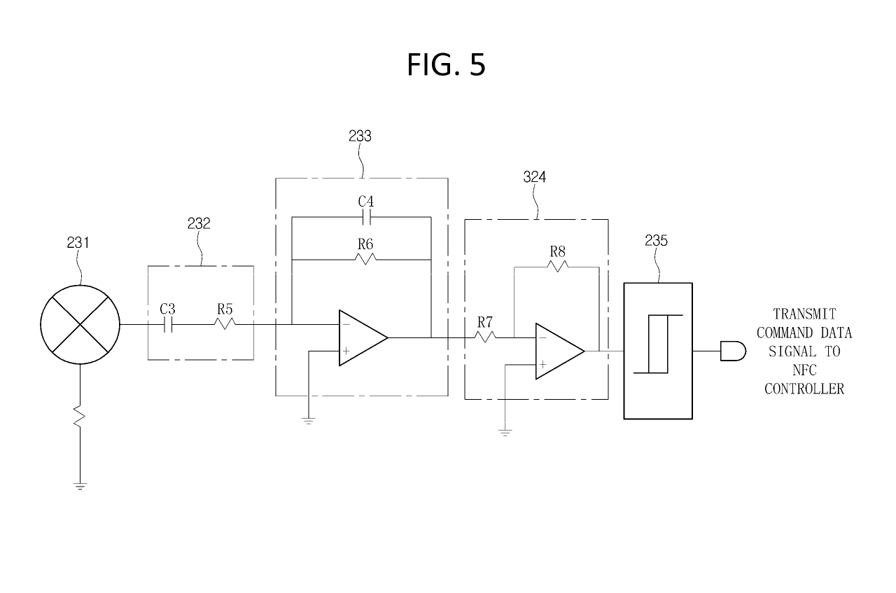

FIG. 6 is a flowchart illustrating a process of driving one-shot call mode using the NFC controller according to an embodiment of the present invention;

FIG. 7 is a flowchart illustrating a process of driving one-shot SMS mode using the NFC controller according to an embodiment of the present invention;

FIG. 8 is a flowchart illustrating a process of driving one-shot Internet access mode using the NFC controller according to an embodiment of the present invention;

FIG. 9 is a view illustrating a process of linking the telephone number of a vehicle owner to the display of the mobile terminal and connecting a call when the mobile terminal provided with the NFC controller is tagged with an RFID tag attached to the windshield of a vehicle according to an embodiment of the present invention;

FIG. 10 is a view illustrating a process of linking SMS text to the display of the mobile terminal and then transmitting the SMS text when the mobile terminal provided with the NFC controller is tagged with an RFID tag attached to the windshield of a vehicle according to an embodiment of the present invention;

FIG. 11 is a view illustrating a process of linking the homepage of a household electric appliance manufacturing company to the display of the mobile terminal and then connecting to the Internet when the mobile terminal provided with the NFC controller is tagged with an RFID tag attached on the windshield of a vehicle according to an embodiment of the present invention; and

FIG. 12 is a flowchart illustrating an automatic transmission method using a mobile terminal and having a one-shot call function, a one-shot SMS function, and a one-shot Internet access function performed through an NFC controller according to an embodiment of the present invention.

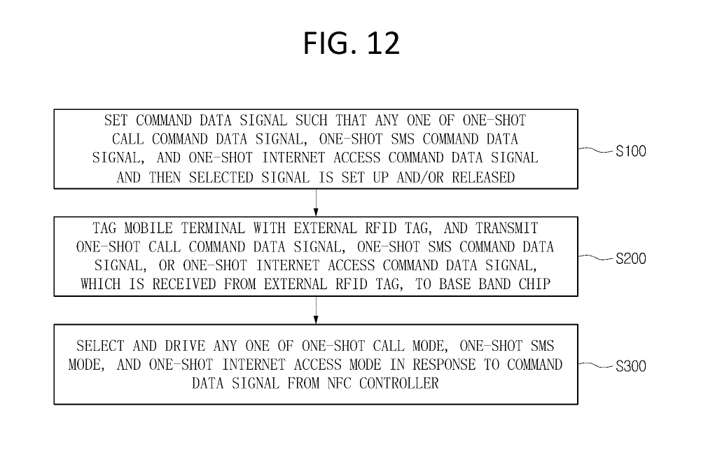

### DETAILED DESCRIPTION OF THE EMBODIMENTS

Reference now should be made to the drawings, in which the same reference numerals are used throughout the different drawings to designate the same or similar components.

Embodiments of the present invention will be described in detail below with reference to the attached drawings.

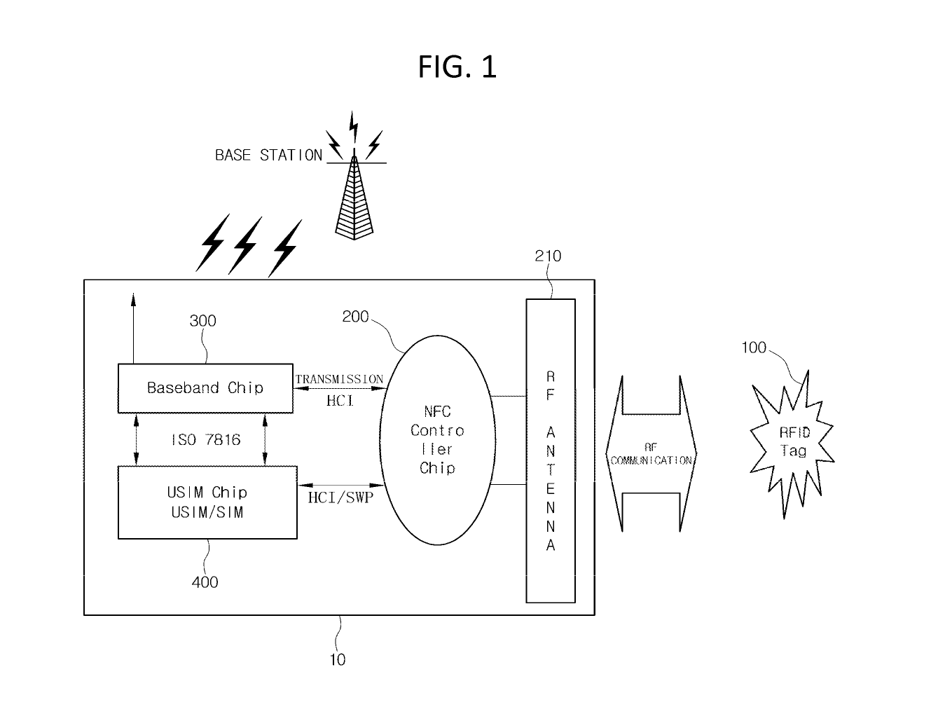

FIG. 1 is a block diagram illustrating the components of an automatic transmission apparatus using a mobile terminal 10 and having a one-shot call function, a one-shot SMS function, and a one-shot Internet access function performed through an NFC controller according to an embodiment of the present invention. The automatic transmission apparatus includes an RFID tag 100, a mobile terminal 10 having an NFC controller 200, and a base band chip 300.

First, the RFID tag 100 will be described.

The RFID tag 100 is attached to a specific location, includes any one signal selected from among a one-shot call command data signal, a one-shot SMS command data signal and a one-shot Internet access command data signal, performs NFC with the NFC controller 200 over a band of 13.56 MHz, and is configured in the form of a circular or rectangular sticker.

The RFID tag 100 according to an embodiment of the present invention includes an RF antenna for 13.56 MHz which corresponds to that of the mobile terminal, and a command transmission unit which transmits a command data signal to the RF antenna of the mobile terminal.

Here, the command data signal includes the one-shot call command data signal, the one-shot SMS command data signal, and the one-shot Internet access command data signal.

The RFID tag 100 according to an embodiment of the present invention may be attached to each of the windshield of a vehicle, a card reader for vehicle entrance/exit, and the trade mark display portion of a household electric appliance.

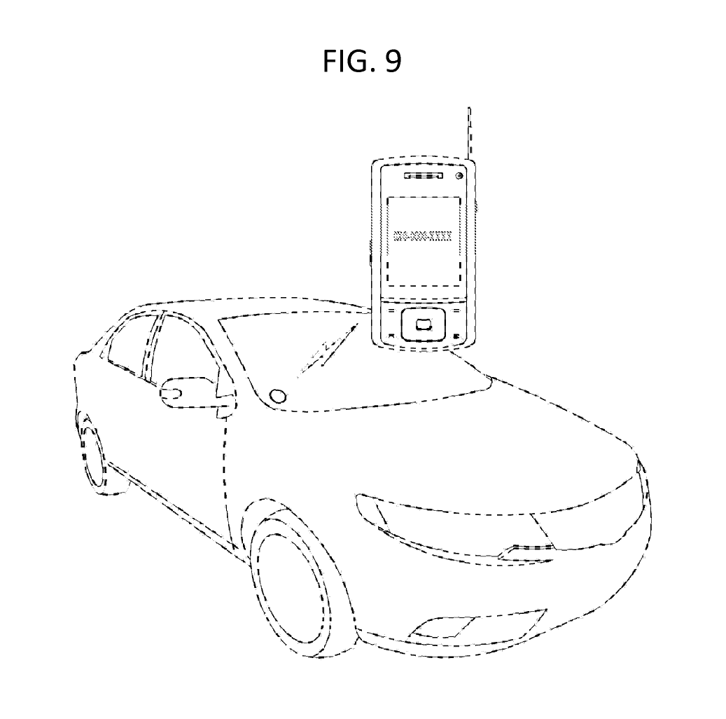

The one-shot call command data signal is a command data signal used to drive the base band chip 300 in one-shot call mode when telephone number information has been stored in the RFID tag 100, as shown in FIG. 9.

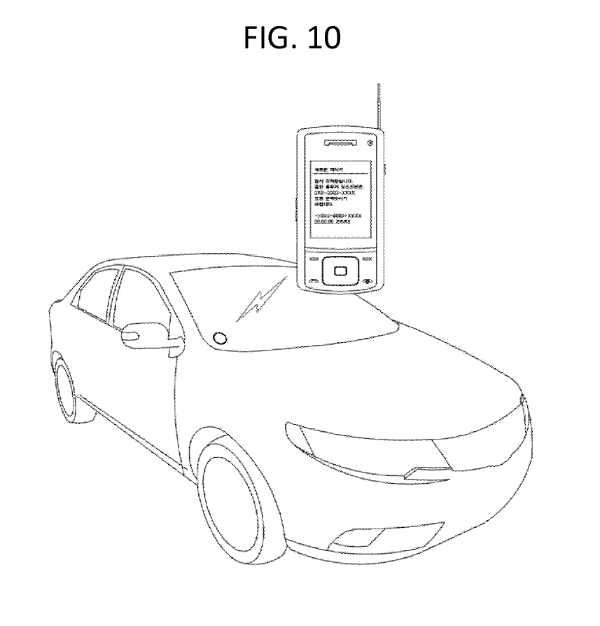

The one-shot SMS command data signal is a command data signal used to drive the base band chip in one-shot SMS mode when SMS data (for example, “If you need to this car moved, please call me at 0X0-0000-XXXX”) has been stored in the RFID tag, as shown in FIG. 10.

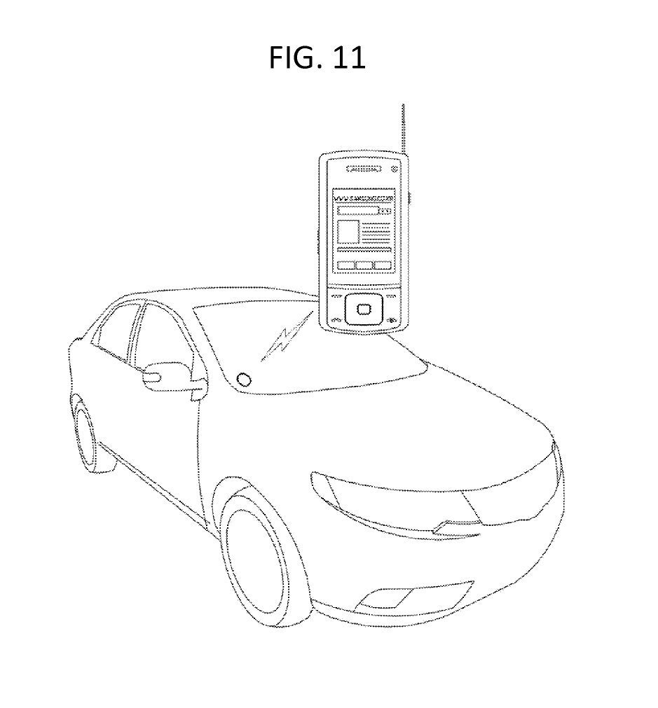

As described above, the one-shot Internet access command data signal is a command data signal used to drive the base band chip in one-shot Internet access mode when domain address information (for example, www.samsung.co.kr) has been stored in the RFID tag, as shown in FIG. 11.

Next, the NFC controller 200 according to an embodiment of the present invention will be described.

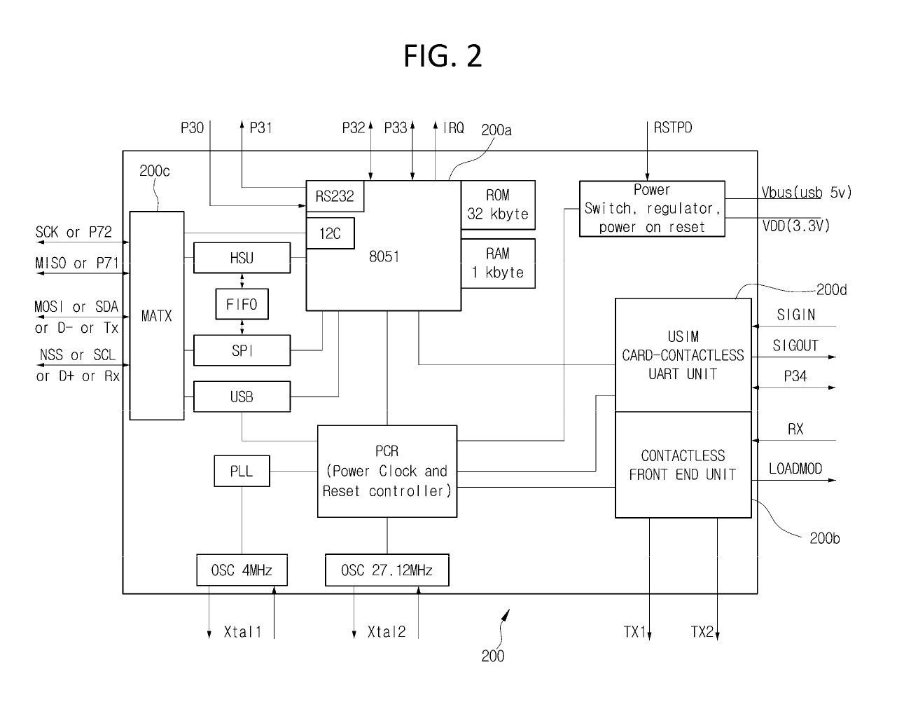

The NFC controller 200 is electrically connected to the base band chip provided in the mobile terminal, performs NFC with the external RFID tag over a band of 13.56 MHz via the RF antenna, and transmits any one of the one-shot call command data signal, the one-shot SMS command data signal and the one-shot Internet access command data signal, which is received from the external RFID tag, to the base band chip. The NFC controller 200 includes a Read Only Memory (ROM) emulator 200a, a contactless front end unit 200b, a Peer-to-Peer (P2P) communication unit 200c, and a Universal Subscriber Identity Module (USIM) card-contactless Universal Asynchronous Receiver/Transmitter (DART) unit 200d, as shown in FIG. 2.

The ROM emulator 200a performs a function of storing the one-shot call command data signal, the one-shot SMS command data signal or the one-shot Internet access command data signal which is received from the RFID tag via the RF antenna.

The ROM emulator 200a includes an 8051 microprocessor.

The contactless front end unit 200b has a reader mode function. The contactless front end unit 200b performs functions of transmitting the command data signal which is contactlessly received via the RF antenna 210 to the ROM emulator 200a and exchanging information about response data transmitted from the base band chip via the RF antenna.

The contactless front end unit 200b includes an RX terminal to which the Schmitt trigger 235 of the receiver circuit unit is connected, and functions to receive the one-shot Internet access command data signal which is read and received via the RF antenna in an RF manner (contactlessly).

The contactless front end unit 200b has TX terminals to which the input and output terminals of the tag circuit unit are connected, and functions to receive the one-shot call command data signal and the one-shot SMS command data signal which are received via the RF antenna, modulate response data transmitted from the NFC controller, and transmit the modulated response data to the RF antenna.

The P2P communication unit 200c exchanges information with another mobile terminal over a band of 13.56 MHz using a P2P method. The P2P communication unit 200c includes a matrix terminal to which the input and output terminals (RX and TX terminals) of another mobile terminal are connected via a wired or wireless connection, transmits the command data signal (the one-shot call command data signal, the one-shot SMS command data signal, or the one-shot Internet access command data signal) stored in the ROM emulator 200a to the NFC controller of another mobile terminal, and receives a response data signal indicative of the completion of transmission from another mobile terminal after the transmission has been completed.

The USIM card-contactless UART unit 200d includes a communication interface input terminal SIGNIN and a communication interface output terminal SIGNO UT which are connected to a USIM card in conformity with a Single Wired Protocol (SWP), transmits the command data signal received from the RFID tag to the USIM card via the RF antenna, and performs network authentication, electronic commerce, and/or global roaming communication service using the USIM card.

Further, the NFC controller 200 according to an embodiment of the present invention is connected to an RF antenna 210, a tag circuit unit 220, and a receiver circuit unit 230 which are in the vicinity thereof.

The RF antenna 210 performs an RF (contactless) tagging function according to the contactlessly connected external RFID tag, and performs functions of receiving the command data signal and transmitting the command data signal to a tuning unit.

The RF antenna 210 is formed of an integrated-type dual antenna in which an initiator (reader) antenna and a tag (target) antenna are integrated in a stacked structure.

The dual antenna includes first and fourth wiring layers configured to form a ground blocking layer and the tag antenna and second and third wiring layers configured to form the initiator (reader) antennas in a Printed Circuit Board (PCB) having a four-layer wiring.

When the RF antenna according to an embodiment of the present invention operates in tag mode, a ground wire connection switch TME is turned on and the RF antenna is used as a 13.56 MHz tag antenna.

That is, the tag antenna of the RF antenna according to an embodiment of the present invention operates in such a way that, when the initiator antenna is not used, the ground wire connection switch TME is turned off and an external RF signal of 13.56 MHz is detected. Here, when the RF signal is detected, the tag antenna determines whether to supply power necessary for the tag circuit unit based on whether external power has been supplied or not.

Tuning units for tuning the received command data signal are provided on one side of the RF antenna according to an embodiment of the present invention.

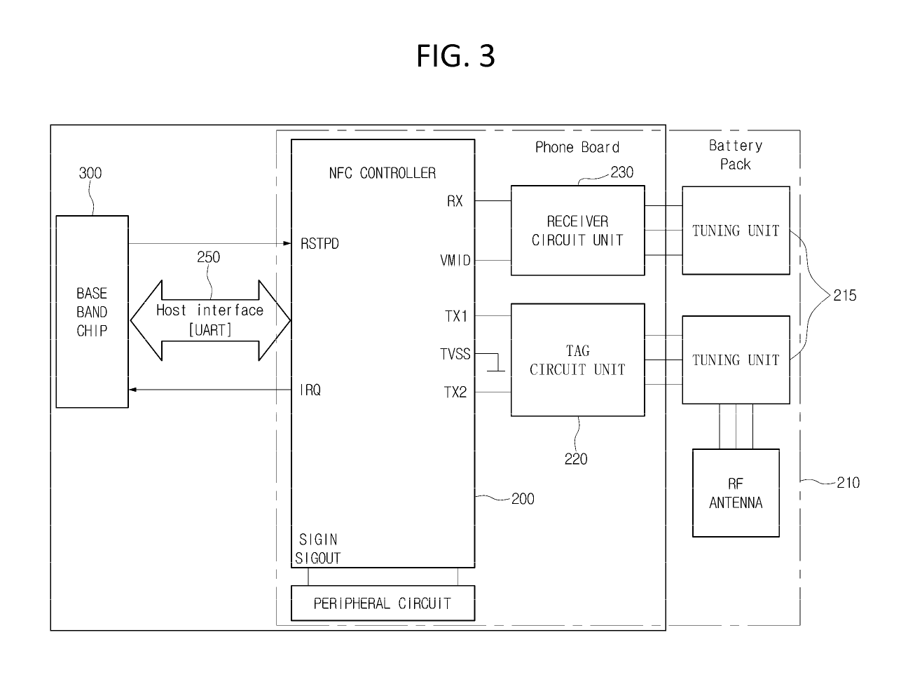

The tuning units smooth the command data signal, received over a band of 13.56 MHz, using a capacitor, and transmit the resulting signal to the receiver circuit unit and the tag circuit unit which are included in the mobile terminal, as shown in FIG. 3.

The RF antenna and the tuning units according to an embodiment of the present invention are provided in the battery case of the mobile terminal.

The tag circuit unit 220 amplifies the one-shot call command data signal and the one-shot SMS command data signal which are received via the RF antenna, transmits the amplified one-shot call command data signal and one-shot SMS command data signal to the contactless front end unit of the NFC controller, modulates response data transmitted from the NFC controller, and transmits the modulated response data to the RF antenna.

The tag circuit unit 220 is connected to the TX1 terminal and TX2 terminal of the NFC controller terminal, as shown in FIG. 3.

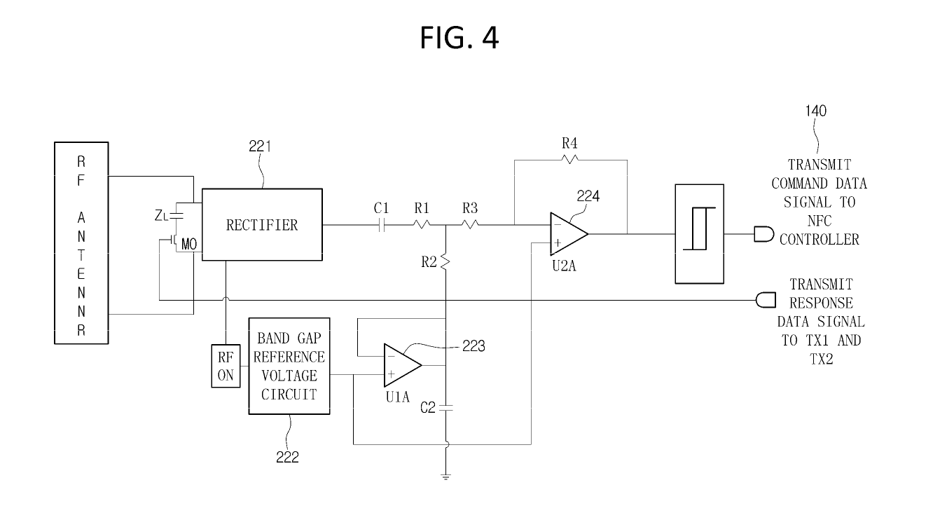

Further, the tag circuit unit 220 according to an embodiment of the present invention includes a rectifier 221, a capacitor C1, a band gap reference voltage circuit 222, a first comparator (Operational Amplifier (OP amp)) 223, and a second comparator (OP amp) 224, as shown in FIG. 4.

Further, when the tag antenna of the RF antenna is driven and external power is supplied, the circuit of each unit operates using the power generated by the rectifier 221 of the tag circuit unit 220.

The reception operation of the tag circuit unit 220 according to an embodiment of the present invention is performed in such a way that the rectifier 221 functions as an envelope detector in order to remove the carrier waves of the one-shot call command data signal and the one-shot SMS command data signal received through the tag antenna, the capacitor C1 blocks Direct Current (DC), the band-gap reference voltage circuit 222 adjusts the level of DC, and the adjusted DC is transmitted to the (+) terminal of the first comparator (OP amp).

Here, the first comparator (OP amp) amplifies the command data signals, and the second comparator (OP amp) 124 demodulates the amplified command data signals into discrete signals and then transmits the discrete signals to the NFC controller.

In contrast, the transmission operation of the tag circuit unit 220 is performed in such a way as to receive the response data signal of the base band chip from the NFC controller 140, perform switching on the response data signal (by a Metal-Oxide-Semiconductor Field-Effect Transistor (MOSFET) terminal), modulate the impedance of ZL, that is, perform load modulation, and than transmit the response data signal to the RF antenna.

The receiver circuit unit 230 passes and amplifies the one-shot Internet access command data signal which is read and received in an RF (contactless) manner via the RF antenna, demodulates the amplified one-shot Internet access command data signal into a digital signal, and then transmits the demodulated one-shot Internet access command data signal to the NFC controller. The receiver circuit unit 230 is connected to the RX terminal of the NFC controller terminal.

The receiver circuit unit 230 according to an embodiment of the present invention performs mixing on the one-shot Internet access command data signal using a mixer unit 231, passes the resulting one-shot Internet access command data signal through a high pass filter 232, including a capacitor C3 and a register R5, and a low pass filter 233, including a register R6 and a capacitor C4, amplifies the resulting one-shot Internet access command data signal using an OP amp 234 including registers R7 and R8, and then inputs the amplified one-shot Internet access command data signal to the RX terminal of the NFC controller through the Schmitt trigger 235.

Next, the base band chip 300 according to an embodiment of the present invention will be described.

The base band chip 300 is electrically connected to the NFC controller 200, is driven in one-shot call mode 310 in response to the one-shot call command data signal transmitted from the NFC controller 200, is driven in one-shot SMS mode 320 in response to the one-shot SMS command data signal, and is driven in one-shot Internet access mode 330 in response to the one-shot Internet access command data signal.

The base band chip 300 is configured as the base band chip of the mobile terminal, and controls the overall command processing of the mobile phone and its own hardware function.

The base band chip 300 includes an input terminal to which the interrupt request terminal IRQ of the NFC controller is connected, receives a command data signal from the RFID tag using the interrupt event signal of the NFC controller 200, and transmits the terminal process response data signal of the base band chip 300, which operates based on an external command through the UART host interface unit of the NFC controller 200, to the NFC controller 200.

Further, the base band chip 300 includes another input terminal to which the USIM card is connected, and receives the command data signals from the RFID tag after a network has been authenticated.

The one-shot call mode 310 is application mode in which a phone number stored in the RFID tag is automatically linked to and a call is connected in response to the one-shot call command data signal transmitted from the RFID tag via the interrupt event signal of the NFC controller.

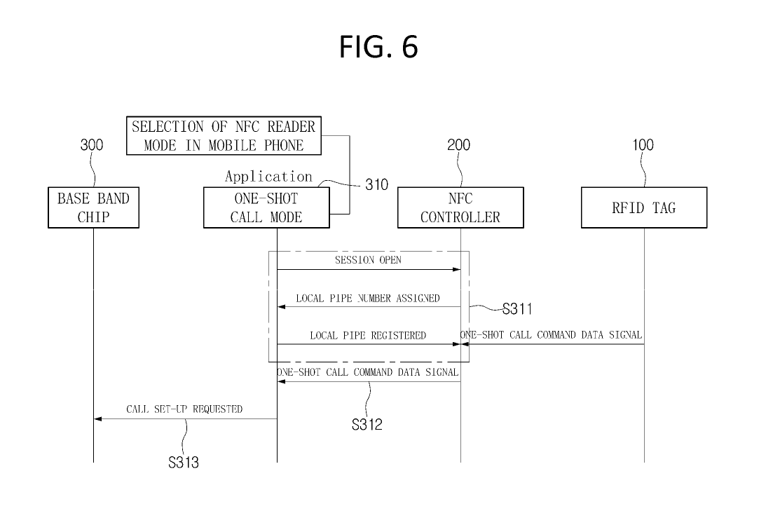

As shown in FIG. 6, a session is open when the one-shot call mode is driven.

Thereafter, a local pipe number is assigned and a local pipe is registered.

Here, the registration of the local pipe means the reservation of the one-shot call mode with the NFC controller when information is received in a RF manner.

Thereafter, the telephone number information of the one-shot call command data signal transmitted from the RFID tag is received via the interrupt event signal of the NFC controller.

Thereafter, a telephone number is extracted from the telephone number information, and a call is requested (a call is set up).

Here, the call request (call set-up) is performed using an instruction including unique information about a base band chip manufacturer.

The one-shot SMS mode 320 is application mode in which SMS including specific information is linked to the display of the mobile terminal and then the SMS is activated in response to the one-shot SMS command data signal transmitted from the RFID tag via the interrupt event signal of the NFC controller.

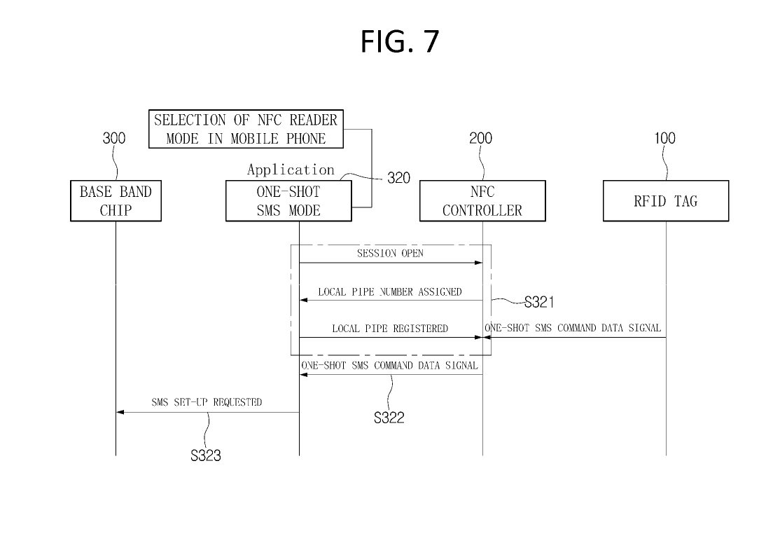

As shown in FIG. 7, a session is open when the one-shot SMS mode is driven.

Thereafter, a local pipe number is assigned and a local pipe is registered.

Thereafter, the SMS information of the one-shot SMS command data signal transmitted from the RFID tag is received via the interrupt event signal of the NFC controller.

Thereafter, SMS is requested (SMS is set up) in order to link the SMS to the display of the mobile terminal and activate the SMS on the display of the mobile terminal.

Here, the SMS request (SMS set-up) is performed using the instruction including the unique information about the base band chip manufacturer.

[SMS Request (SMS set-up) instructions]
ser = serial.Serial(‘/dev/ttyS0’, 115200, timeout=1) # connect
a serial port
ser.write(“AT*ESMS=1\r”) # activate a text message
sending function.
serial_result = ser.readlines( )
ser.write(“ATE0\r”)
serial_result = ser.readlines( )
ser.write(“ATV1\r”)
serial_result = ser.readlines( )
ser.write(“AT+CHV\r”) # disconnect a call
serial_result = ser.readlines( )
ser.write(“AT+CSQ?/r”) # test a device
serial_result = ser.readlines( )
ser.write(“AT+CDV *0661\r”) # connect a call
serial_result = ser.readlines( )
serial_result = ser.readlines( )
ser.write(“AT*MOREQ 0, caller phone number, receiver phone

number, 4098, send a first text message\r”) # send a first
text message

serial_result = ser.readlines( )
ser.write(“AT*MOREQ 1, caller phone number, receiver phone

number, 4098 send a second text message\r”) # send a second
text message

serial_result = ser.readlines( )
ser.write(“AT+CHV\r”) # disconnect the call
serial_result = ser.readlines( )
ser.close( ) # disconnect the serial port

The one-shot Internet access mode 330 is application mode in which a specific address is directly linked to using the web browser of the mobile terminal based on an Internet access address stored in the RFID tag in response to the one-shot Internet access command data signal transmitted from the RFID tag via the interrupt event signal of the NFC controller.

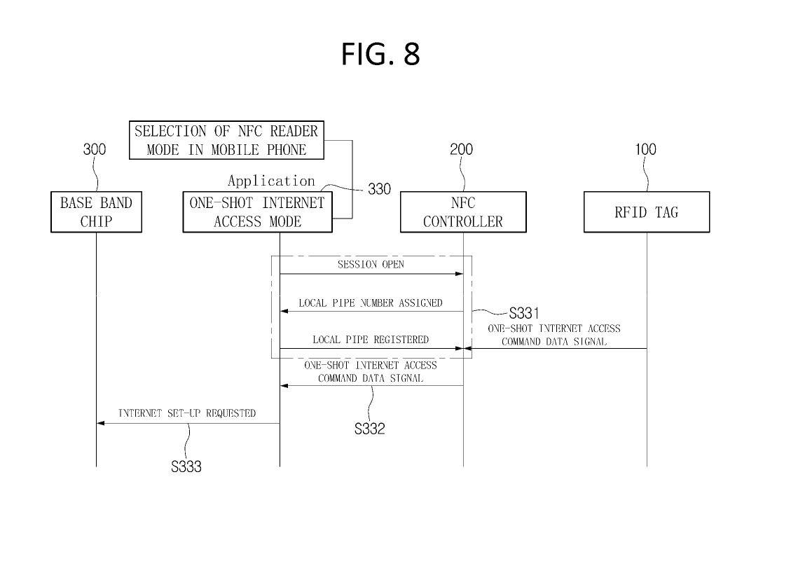

As shown in FIG. 8, a session is open when the one-shot Internet access mode is driven.

Thereafter, a local pipe number is assigned and a local pipe is registered.

Thereafter, the Internet address information of the one-shot Internet access command data signal transmitted from the RFID tag is received via the interrupt event signal of the NFC controller.

Thereafter, Internet access is requested (the Internet is set up) such that a specific address is linked to using the web browser of the mobile terminal based on an Internet access address.

Here, the Internet access request (Internet set-up) is performed using the instructions including the unique information about the base band chip manufacturer.

An automatic transmission method using a mobile terminal and having a one-shot call function, a one-shot SMS function, and a one-shot Internet access function performed through an NFC controller according to an embodiment of the present invention will be described below.

First, a command data signal is set in an external RFID tag so that one of a one-shot call command data signal, a one-shot SMS command data signal, and a one-shot Internet access command data signal can be selected and then the selected signal can be set up and released.

Next, a mobile terminal is tagged with the external RFID tag, and thereby the one-shot call command data signal, the one-shot SMS command data signal, or the one-shot Internet access command data signal, which is received from the external RFID tag, is transmitted to the base band chip.

Next, one of the one-shot call mode 310, the one-shot SMS mode 320, and the one-shot Internet access mode 330 is selected and driven in response to the command data signal transmitted from the NFC controller.

[One-Shot CALL Mode]

The one-shot call mode 310 is driven in response to the command data signal transmitted from the NFC controller as follows:

First, when the one-shot call mode is driven, a session is open (S311).

Thereafter, a local pipe number is assigned, and a local pipe is registered.

Thereafter, the telephone number information of the one-shot call command data signal transmitted from the RFID tag is received via the interrupt event signal of the NFC controller (S312).

Thereafter, a telephone number is extracted from the telephone number information, and a call is requested (a call is set up) (S313).

[One-Shot SMS Mode]

The one-shot SMS mode 320 is driven in response to the command data signal transmitted from the NFC controller as follows:

First, when the one-shot SMS mode is driven, a session is open (S321).

Thereafter, a local pipe number is assigned, and a local pipe is registered.

Thereafter, the SMS information of the one-shot SMS command data signal transmitted from the RFID tag is received via the interrupt event signal of the NFC controller (S322).

Thereafter, an SMS is requested (SMS is set up) such that the SMS is linked to the display of the mobile terminal and is then activated (S323).

[One-Shot Internet Access Mode]

The one-shot Internet access mode 330 is driven in response to the command data signal transmitted from the NFC controller as follows:

First, when the one-shot Internet access mode is driven, a session is open (S331).

Thereafter, a local pipe number is assigned, and a local pipe is registered.

Thereafter, the Internet address information of the one-shot Internet access command data signal transmitted from the RFID tag is received via the interrupt event signal of the NFC controller (S332).

Thereafter, Internet access is requested (the Internet is set up) such that a specific address can be linked to using the web browser of the mobile terminal based on an Internet access address (S333).

As described above, the present invention enables the provision of a one-shot call function, a one-shot SMS function, and a one-shot Internet access function to the old and weak and physically disabled people who have trouble using a mobile terminal, so that there are advantages of rapid communication with another party and activation of stickers to which RFID tags have been attached.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An automatic transmission apparatus comprising:
at least one Radio Frequency Identification (RFID) tag including a command data signal comprised of at least one of a one-shot call command data signal, a one-shot Short Message Service (SMS) command data signal and a one-shot Internet access command data signal; and
a mobile terminal comprising:
a Radio Frequency (RF) antenna;
a base band chip; and
a Near Field Communication (NFC) controller electrically connected to the base band chip, the NFC controller configured to perform NFC with the RFID tag via the RF antenna, and to transmit the command data signal received from the Radio Frequency Identification (RFID) tag to the base band chip.

2. The automatic transmission apparatus as set forth in claim 1, wherein the NFC controller comprises:
a Read Only Memory (ROM) emulator for storing the command data signal received from the RFID tag via the RF antenna;
a contactless front end unit to transmit the command data signal contactlessly received via the RF antenna to the ROM emulator, and exchange information about response data transmitted from the base band chip via the RF antenna;
a Peer-to-Peer (P2P) communication unit to exchange information with another mobile terminal using a P2P method; and
a Universal Subscriber Identity Module (USIM) card-contactless Asynchronous Receiver/Transmitter (UART) unit including a communication interface input terminal and a communication interface output terminal which are connected to a USIM card in conformity with a Single Wired Protocol (SWP), the Universal Subscriber Identity Module (USIM) card-contactless Asynchronous Receiver/Transmitter (UART) unit transmitting the command data signal received from the RFID tag to the USIM card via the RF antenna and performing network authentication, electronic commerce, and global roaming communication service using the USIM card.

3. The automatic transmission apparatus as set forth in claim 1, wherein the base band chip is electrically connected to the NFC controller, is driven in a one-shot call mode in response to the one-shot call command data signal transmitted from the NFC controller, is driven in a one-shot SMS mode in response to the one-shot SMS command data signal, and is driven in a one-shot Internet access mode in response to the one-shot Internet access command data signal.

4. A method of automatic transmitting a signal in an automatic transmission apparatus, the method comprising:
setting a command data signal in an external RFID tag, the command data signal selected from among a one-shot call command data signal, a one-shot Short Message Service (SMS) command data signal and a one-shot Internet access command data signal;
tagging a mobile terminal with the external RFID tag to receive the command data signal from the external RFID tag and transmit the command data signal to a base band chip;
selecting any one of a one-shot call mode, a one-shot SMS mode, and a one-shot Internet access mode in response to the command data signal transmitted from the NFC controller; and
driving the selected mode.

5. The method as set forth in claim 4, wherein the selected mode is the one-shot call mode, and the driving of the one-shot call mode comprises:
opening a session;
receiving telephone number information of the one-shot call command data signal from the RFID tag via an interrupt event signal of the NFC controller; and
extracting a telephone number from the telephone number information, and requesting a call.

6. The method as set forth in claim 4, wherein the selected mode is the one-shot SMS mode, and the driving of the one-shot SMS mode comprises:
opening a session;
receiving SMS information of the one-shot SMS command data signal from the RFID tag via an interrupt event signal of the NFC controller; and
requesting an SMS such that the SMS is linked to a display of the mobile terminal and then activated.

7. The method as set forth in claim 4, wherein the selected mode is the one-shot Internet access mode, and the driving of the one-shot Internet access mode comprises:
opening a session;
receiving Internet address information of the one-shot Internet access command data signal from the RFID tag via an interrupt event signal of the NFC controller; and
requesting Internet access such that a specific address is directly linked to using a web browser of the mobile terminal based on an Internet access address.

8. The automatic transmission apparatus of claim 1, wherein the NFC controller performs NFC with the RFID tag over a band of 13.56 MHz.

9. The automatic transmission apparatus as set forth in claim 1, wherein the command data signal comprises the one-shot call command data signal.

10. The automatic transmission apparatus as set forth in claim 1, wherein the command data signal comprises the one-shot SMS command data signal.

11. The automatic transmission apparatus as set forth in claim 1, wherein the command data signal comprises the one-shot Internet access command data signal.

12. The automatic transmission apparatus as set forth in claim 2, wherein the mobile terminal further comprises a tag circuit unit to amplify the one-shot call or SMS command data signal received via the RF antenna, transmit the amplified command data signal to the contactless front end unit of the NFC controller, modulate response data transmitted from the NFC controller, and transmit the modulated response data to the RF antenna; and
a receiver circuit unit to pass and amplify the one-shot Internet access command data signal which is read and received via the RF antenna, demodulate the amplified one-shot Internet access command data signal into a digital signal, and then transmit the demodulated one-shot Internet access command data signal to the NFC controller.

13. The automatic transmission system of claim 1, wherein the mobile terminal is a mobile phone.

14. A mobile terminal performing Near Field Communication with an external Radio Frequency Identification (RFID) tag, the mobile terminal comprising:
a Radio Frequency (RF) antenna;
a Near Field Communication (NFC) controller configured to perform NFC with the external RFID tag via the RF antenna, and to transmit a command data signal received from the external Radio Frequency Identification (RFID) tag to a base band chip, the command data signal comprising at least one of a one-shot call command data signal, a one-shot SMS command data signal, a one-shot Internet access command data signal and a combination thereof, and
the base band chip electrically connected to the NFC controller, the base band chip being driven in a one-shot call mode in response to the one-shot call command data signal transmitted from the NFC controller, in a one-shot SMS mode in response to the one-shot SMS command data signal, and in a one-shot Internet access mode in response to the one-shot Internet access command data signal.

15. The mobile terminal of claim 14, wherein the NFC controller comprises:
a Read Only Memory (ROM) emulator for storing the command data signal received from the external RFID tag via the RF antenna;
a contactless front end unit to transmit the command data signal contactlessly received via the RF antenna to the ROM emulator, and exchange information about response data transmitted from the base band chip via the RF antenna;
a Peer-to-Peer (P2P) communication unit to exchange information with another mobile terminal using a P2P method; and
a Universal Subscriber Identity Module (USIM) card-contactless Asynchronous Receiver/Transmitter (UART) unit including a communication interface input terminal and a communication interface output terminal which are connected to a USIM card in conformity with a Single Wired Protocol (SWP), the Universal Subscriber Identity Module (USIM) card-contactless Asynchronous Receiver/Transmitter (UART) unit transmitting the command data signal received from the external RFID tag to the USIM card via the RF antenna and performing network authentication, electronic commerce, and global roaming communication service using the USIM card.

16. The mobile terminal of claim 15, further comprising:
a tag circuit unit to amplify the one-shot call or SMS command data signal received via the RF antenna, transmit the amplified command data signal to the contactless front end unit of the NFC controller, modulate response data transmitted from the NFC controller, and transmit the modulated response data to the RF antenna; and
a receiver circuit unit to pass and amplify the one-shot Internet access command data signal which is read and received via the RF antenna, demodulate the amplified one-shot Internet access command data signal into a digital signal, and then transmit the demodulated one-shot Internet access command data signal to the NFC controller.

17. The automatic transmission system of claim 14, wherein the mobile terminal is a mobile phone.
